(19) United States
(12) Patent Application Publication
(10) Pub. No.: US 2021/0191433 A1
(43) Pub. Date: Jun. 24, 2021

(54) WATER PURIFIER AND METHOD FOR CONTROLLING THE SAME

(71) Applicant: Samsung Electronics Co., Ltd., Suwon-si (KR)

(72) Inventors: Wanhoi KIM, Suwon-si (KR); Sungho CHO, Suwon-si (KR)

(73) Assignee: Samsung Electronics Co., Ltd., Suwon-si (KR)

(21) Appl. No.: 17/123,615

(22) Filed: Dec. 16, 2020

(30) Foreign Application Priority Data
Dec. 20, 2019 (KR) 10-2019-0171486

(51) Int. Cl. G05D 16/20; C02F 1/00

(52) U.S. Cl. CPC G05D 16/204; C02F 1/008; C02F 2209/03; C02F 2201/005; C02F 1/001

(57) ABSTRACT

Disclosed is a water purifier having a self-recovery function of a valve. The water purifier includes: a piping part configured to have a flow path between an inlet into which water is introduced and an outlet through which water is dispensed; a plurality of valves configured to be provided in the flow path of the piping part; and a processor configured to control to open at least one of the plurality of valves to perform a water dispensing operation of dispensing water through the outlet and control to open valves other than at least one of the plurality of valves to perform a recovery operation of reducing water pressure applied to the at least one valve.

### CROSS-REFERENCE TO RELATED APPLICATION

This application is based on and claims priority under 35 U.S.C. § 119 to Korean Patent Application No. 10-2019-0171486, filed on Dec. 20, 2019, in the Korean Intellectual Property Office, the disclosure of which is herein incorporated by reference in its entirety.

### BACKGROUND

### 1. Field

The disclosure relates to a water purifier and a method for the same.

### 2. Discussion of Related Art

A water purifier includes a filter module that filters introduced water, a hot water module that heats the filtered water, and a cooling module that cools the filtered water. Such a water purifier includes a plurality of valves that controls dispensing of filtered water, hot water, or cold water until the water is finally dispensed.

The plurality of valves applied to the water purifier may not be opened and closed smoothly when the plurality of valves are subjected to rapid water pressure when opened or have foreign objects sandwiched therein At this time, there is an inconvenience that a user needs to get after-sales service.

### SUMMARY

According to an embodiment, a water purifier includes: a piping part configured to have a flow path between an inlet into which water is introduced and an outlet through which water is dispensed; a plurality of valves configured to be provided in the flow path of the piping part; and a processor configured to control to open at least one of the plurality of valves to perform a water dispensing operation of dispensing water through the outlet and control to open valves other than at least one of the plurality of valves to perform a recovery operation of reducing water pressure applied to the at least one valve.

The flow path may include a first main flow path on the inlet side, a second main flow path on the outlet side, and two or more subflow paths that are branches of the first main flow path or the second main flow path.

The at least one valve may include a valve provided in the first main flow path, a valve provided in one of the two or more subflow paths, and a valve provided in the second main flow path.

The other valves may include a valve provided in the rest of the two or more subflow paths.

The water purifier may further include: a filter module configured to be provided in the first main flow path and filter the introduced water; a hot water module configured to be provided in one of the two or more subflow paths and heat water filtered by the filter module; and a cooling module configured to be provided in the other one of the two or more subflow paths and cool the water filtered by the filter module.

The plurality of valves may include: a first valve configured to be provided in the first main flow path at a rear end of the filter module; a second valve configured to be provided at a rear end of the hot water module; a third valve configured to be provided at a rear end of the cooling module; a fourth valve configured to be provided in another one of the two or more subflow paths; and a fifth valve configured to be provided in a second main flow path on the outlet side.

The flow path may include a fourth subflow path that is a branch of a second main flow path at a front end of the fifth valve, and the plurality of valves may include a sixth valve that is provided in the fourth subflow path.

The processor may be configured to control to sequentially open the fifth valve, at least one of the second valve, the third valve, or the fourth valve, and the first valve, upon a command to dispense at least one of filtered water, hot water, or cold water.

The processor may be configured to control to sequentially shut-off the first valve, at least one of the second valve, the third valve, or the fourth valve, and the fifth valve, upon a command to cut off at least one of filtered water, hot water, or cold water.

The processor may be configured to control to shut-off the first valve and open the second to sixth valves as the water dispensing operation is not normally performed.

The processor may be configured to control to shut-off the first valve and the fifth valve and open the sixth valve while opening the second to fourth valves as the water dispensing operation is not normally performed.

The processor may be configured to control to shut-off the first valve and open a predefined valve of the second to sixth valves as the water dispensing operation is not normally performed.

The processor may be configured to control to shut-off at least one of the plurality of valves and open the other valves as the water dispensing operation is not normally performed.

The processor may be configured to repeatedly perform a first operation of opening at least one of the plurality of valves, a second operation of shutting-off the at least one valve as the water dispensing operation is not normally performed, and a third operation of opening the other valves, and a third operation of opening the other valves a predefined number of times.

The processor may be configured to control to shut-off at least one of the plurality of valves and open the other valves in a predefined order as the water dispensing operation is not normally performed.

A method of controlling a water purifier according to an embodiment of the disclosure is provided. The water purifier has a piping part that has a flow path between an inlet into which water is introduced and an outlet through which water is dispensed, and a plurality of valves that are provided in the flow path of the piping part. The method for controlling a water purifier includes: controlling to open at least one of the plurality of valves to perform a water dispensing operation of dispensing water through the outlet; detecting whether the at least one valve is normally operated, and controlling to open valves other than at least one of the plurality of valves to perform a recovery operation of reducing water pressure applied to the at least one valve.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 is a block diagram illustrating a configuration of a water purifier according to a first embodiment of the disclosure.

FIG. 2 is a diagram illustrating a shut-off state of a valve according to an embodiment of the disclosure.

FIG. 3 is a diagram illustrating an open state of the valve according to the embodiment of the disclosure.

FIG. 4 is a block diagram illustrating a configuration of a valve installed in a piping part of a water purifier according to an embodiment of the disclosure.

FIG. 5 is a flowchart illustrating a control method for dispensing hot water from a water purifier according to an embodiment of the disclosure.

FIG. 6 is a flowchart illustrating a control method for cutting-off hot water of a water purifier according to an embodiment of the disclosure.

FIG. 7 is a flowchart illustrating a control method for dispensing cold water of a water purifier according to an embodiment of the disclosure.

FIG. 8 is a flowchart illustrating a control method for cutting-off cold water of a water purifier according to an embodiment of the disclosure.

FIG. 9 is a flowchart illustrating a control method for dispensing purified water of a water purifier according to an embodiment of the disclosure.

FIG. 10 is a flowchart illustrating a control method for cutting-off purified water of a water purifier according to an embodiment of the disclosure.

FIG. 11 is a flowchart illustrating a method for self-recovering a valve of a water purifier according to a first embodiment of the disclosure.

FIG. 12 is a flowchart illustrating a method for self-recovering a valve of a water purifier according to a second embodiment of the disclosure.

### DETAILED DESCRIPTION

Hereinafter, embodiments of the disclosure will be described in detail with reference to the accompanying drawings. In the drawings, the same reference numbers or signs refer to components that perform substantially the same function, and the size of each component in the drawings may be exaggerated for clarity and convenience. However, the technical idea and the core configuration and operation of the disclosure are not limited only to the configuration or operation described in the following examples. In describing the disclosure, if it is determined that a detailed description of the known technology or configuration related to the disclosure may unnecessarily obscure the subject matter of the disclosure, the detailed description thereof will be omitted.

In the disclosure, an expression “have”, “may have”, “include”, “may include”, or the like, indicates existence of a corresponding feature (for example, a numerical value, a function, an operation, a component such as a part, or the like), and does not exclude existence of an additional feature.

In the disclosure, an expression “A or B”, “at least one of A and/or B”, “one or more of A and/or B”, or the like, may include all possible combinations of items enumerated together. For example, “A or B”, “at least one of A and B”, or “at least one of A or B” may indicate all of (1) a case in which at least one A is included, (2) a case in which at least one B is included, or (3) a case in which both of at least one A and at least one B are included.

In embodiments of the disclosure, terms including ordinal numbers such as first and second are used only for the purpose of distinguishing one component from other components, and singular expressions include plural expressions unless the context clearly indicates otherwise.

In addition, in the embodiment of the disclosure, terms such as ‘top’, ‘bottom’, ‘left’, ‘right’, ‘inside’, ‘outside’, ‘inner surface’, ‘outer surface’, ‘front’, and ‘rear’ are defined based on the drawings, and shapes or positions of each component are not limited thereby.

An expression “configured (or set) to” used in the disclosure may be replaced by an expression “suitable for”, “having the capacity to” “designed to”, “adapted to”, “made to”, or “capable of” depending on a situation. A term “configured (or set) to” may not necessarily mean “specifically designed to” in hardware. Instead, an expression “an apparatus configured to” may mean that the apparatus may “do” together with other apparatuses or components.

The disclosure is to provide a water purifier that can be self-recovered even in the event of excessive water pressure or sandwich of foreign objects, and a method for controlling the same.

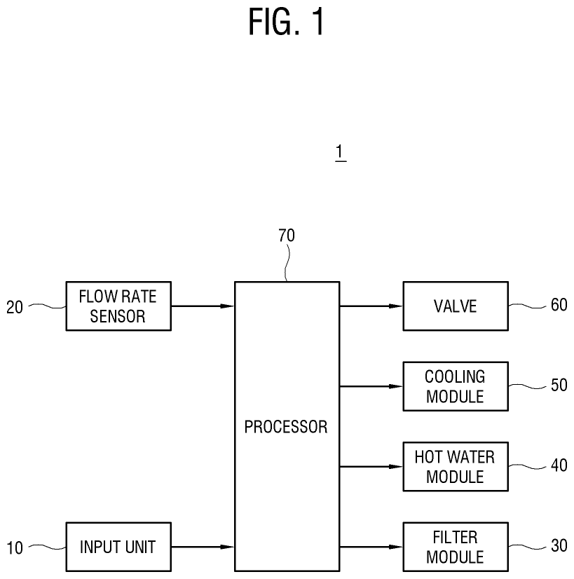

FIG. 1 is a block diagram illustrating a configuration of a water purifier 1 according to a first embodiment of the disclosure.

Referring to FIG. 1, the water purifier 1 includes an input unit 10, a flow rate sensor 20, a filter module 30, a hot water module 40, a cooling module 50, a valve 60, and a processor 70.

The input unit 10 may receive a water dispensing command or a water cutting-off command such as purified water, hot water, or cold water from a user through a button or a touch display screen. In addition, the input unit 10 may receive a user desired setting value, that is, a temperature of water, an amount of water dispensed, and whether water is sterilized, and the like.

The flow rate sensor 20 may measure the amount of water dispensed as a whole. The flow rate sensor 20 may be provided at a rear end of the filter module 30 or the valve 60 or implemented integrally with the valve 60 to measure the amount of water passing through the valve 60.

The filter module 30 may filter impurities contained in water to be introduced. The filter module 30 may include a hollow fiber membrane filter, a membrane filter, a compressed activated carbon filter, or the like. The filter module 30 may also include an ultraviolet lamp for ultraviolet sterilization.

The hot water module 40 may include a heater that heats the filtered water.

The cooling module 50 may convert the filtered water into cold water or ice. The cooling module 50 may include an evaporator through which a refrigerant flows to exchange heat with filtered water, a compressor that compresses the heat-exchanged refrigerant, a condenser that condenses the compressed refrigerant, and the like.

The valve 60 may block or open a flow path through which water flows under the control of the processor 70. The valve 60 may be implemented as a solenoid valve, for example.

The processor 70 may control the hot water module 40, the cooling module 50, and the valve 60 according to a command or set value input through the input unit 10 or a flow rate detected by the flow rate sensor 20.

The processor 70 may control to open or close at least one of the plurality of valves 60 according to a water dispensing command or a water cutting-off command. At this time, the processor 70 may sequentially open valves provided from an outlet side to an inlet side at predetermined time intervals during water dispensing. In addition, the processor 70 may sequentially open the valves provided from the inlet side to the outlet side at the predetermined time intervals during water cutting-off.

The processor 70 may open other valves to reduce water pressure applied to at least one valve when it is determined that the at least one valve that is controlled to be opened is malfunctioning. In this case, the determination of the malfunction of the valve may be made based on the flow rate detected by the flow rate sensor 20.

The processor 70 may repeatedly open and close valves other than the malfunctioning valve a predetermined number of times.

The processor 70 includes at least one general-purpose processor that loads at least a part of the control program from the nonvolatile memory in which the control program is installed into the volatile memory and executes the loaded control program, and may be implemented as, for example, a central processing unit (CPU), an application processor (AP), or a microprocessor.

The processor 70 may include a single core, a dual core, a triple core, a quad core, or a multiple-number core thereof. A plurality of processors 70 may be provided. The processor 70 may include, for example, a main processor and a sub processor operating in a sleep mode (for example, a mode in which only standby power is supplied). In addition, the processor, the ROM, and the RAM can be interconnected via an internal bus.

The processor 70 may be implemented as a form included in a main SoC mounted on a PCB embedded in the water purifier 1.

The control program may include a program(s) implemented in at least one of a BIOS, a device driver, an operating system, firmware, a platform, and an application program (application). The application program may be pre-installed or pre-stored at the time of manufacturing of the water purifier 1, or may be installed based on data of the application program received from the outside when used later. The data of the application program may be downloaded to the water purifier 1 from an external server such as an application market. Such an external server is an example of a computer program product, but is not limited thereto.

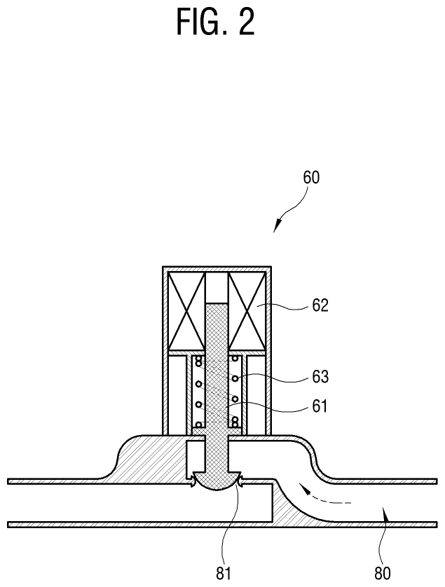

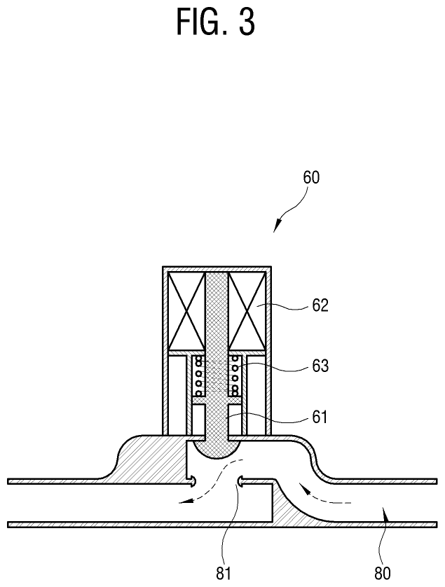

FIG. 2 is a diagram illustrating a shut-off state of the valve 60 according to an embodiment of the disclosure, and FIG. 3 is a diagram illustrating an open state of the valve 60 according to an embodiment of the disclosure.

The valve 60 is a stem 61 that is inserted or detached from an opening 81 of a piping part 80, an electromagnet 62 that may adsorb and separate the stem 61, and a spring 63 that is provided between the stem 61 and the electromagnet 62.

The stem 61 may be made of a ferromagnetic material such as iron that adheres well to the electromagnet 62. The stem 61 has a hemispherical end portion suitable for closing the opening 81 of the piping part 80.

When a current is applied to the electromagnet 62 in FIG. 2, the stem 61 moves in a direction in which the opening 81 is opened as illustrated in FIG. 3. Thereafter, when the application of the current stops, the stem 61 returns to the state of FIG. 2 by the spring 63 and blocks the opening 81.

In the state of FIG. 2, when excessive pressure is applied to the stem 61 due to the introduction of water, a case in which the stem 61 may not be pulled occurs even if the electromagnet 62 operates. Alternatively, the stem 61 may not be separated from the opening 81 by foreign objects sandwiched between the end portion of the stem 61 and the opening 81.

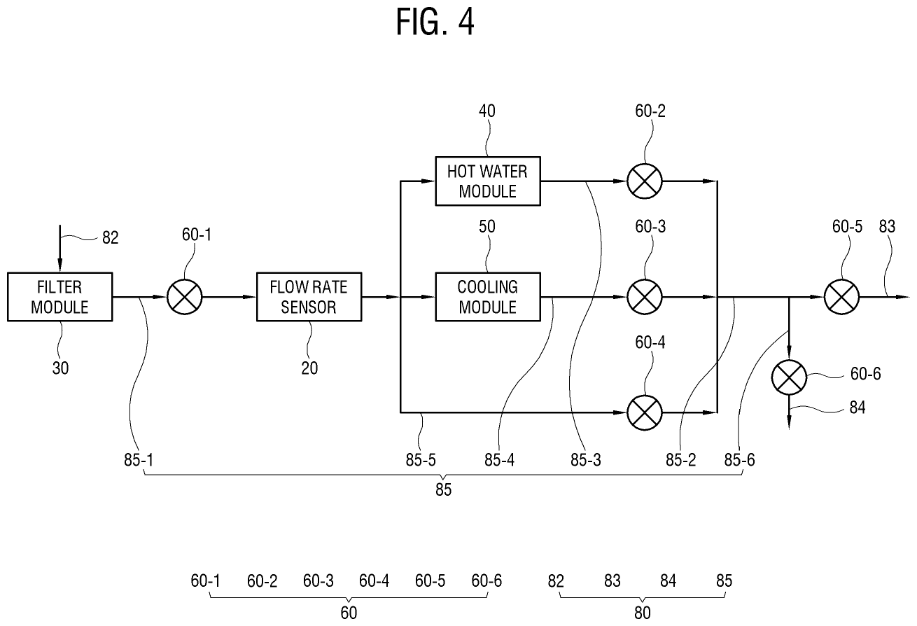

FIG. 4 is a block diagram illustrating a configuration of the valve 60 installed in the piping part 80 of the water purifier 1 according to the embodiment of the disclosure.

Referring to FIG. 4, the piping part 80 may include an inlet 82 into which water is introduced, an outlet 83 through which water is dispensed, a drainage part 84 through which water is dispensed, and a flow path 85 that connects from the inlet 82 to the outlet 83 or the drainage part 84.

The flow path 85 may include a first main flow path 85-1 on the inlet 82 side, a second main flow path 85-2 on the outlet 83 side, first to third subflow paths 85-3, 85-4, and 85-5 provided between the first main flow path 85-1 and the second main flow path 85-2, and a fourth subflow path 85-6 that is branched from the second main flow path 85-2.

The first sub-flow path 85-3, the second sub-flow path 85-4, and the third sub-flow path 85-5 each may be branched from the first main flow path 85-1 to extend in parallel to each other. The fourth sub-flow path 85-6 may branch from the second main flow path 85-2 to extend to the outside. The configuration of the flow path 85 is not limited to that illustrated in FIG. 4.

The first main flow path 85-1 may be provided with the filter module 30, a first valve 60-1, and the flow rate sensor 20.

The second main flow path 85-2 may be provided with a fifth valve 60-5.

The first subflow path 85-3 may be provided with the hot water module 40 and a second valve 60-2.

The second subflow path 85-4 may be provided with the cooling module 50 and a third valve 60-3.

The third subflow path 85-5 may be provided with a fourth valve 60-5.

The fourth subflow path 85-6 may be provided with a sixth valve 60-6.

The configurations of the flow path 85 and the valve 60 of the water purifier 1 are not limited to those illustrated in FIG. 4.

Hereinafter, a method for controlling a water purifier 1 according to an embodiment of the disclosure will be described in detail with reference to the accompanying drawings.

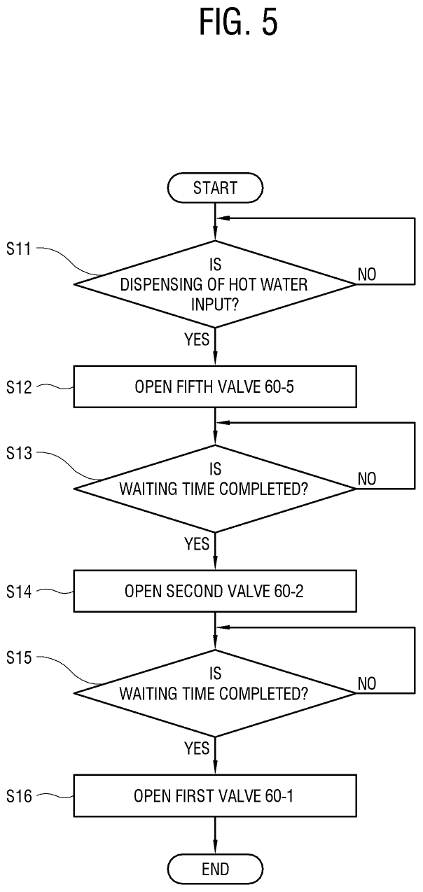

FIG. 5 is a flowchart illustrating a control method for dispensing hot water from a water purifier 1 according to an embodiment of the disclosure.

In operation S11, the processor 70 checks whether a hot water dispensing command is input through the input unit 10.

In operation S12, the processor 70 opens the fifth valve 60-5 when a hot water dispensing command is input through the input unit 10.

In operation S13, the processor 70 determines whether a predetermined waiting time elapses after the fifth valve 60-5 is opened.

In operation S14, the processor 70 opens the second valve 60-2 when the predetermined waiting time elapses after the fifth valve 60-5 is opened.

In operation S15, the processor 70 determines whether the predetermined waiting time elapses after the second valve 60-2 is opened.

In operation S16, the processor 70 opens the first valve 60-1 when the predetermined waiting time elapses after the second valve 60-2 is opened.

As described above, when hot water is dispensed, the processor 70 may sequentially open the fifth valve 60-5, the second valve 60-2, and the first valve 60-1 with the predetermined waiting time, thereby preventing excessive water pressure from being applied to the second valve 60-2 or the fifth valve 60-5. As a result, the second valve 60-2 and the fifth valve 60-5 may not be disturbed by the opening operation according to the water pressure.

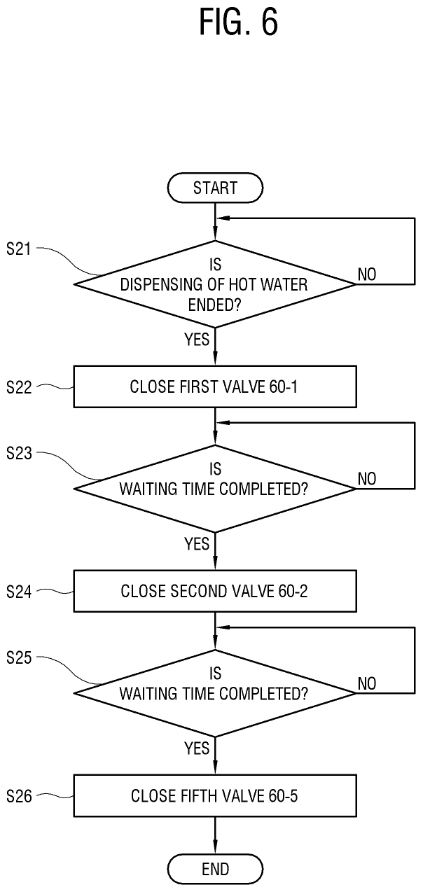

FIG. 6 is a flowchart illustrating a control method for cutting-off hot water of a water purifier 1 according to an embodiment of the disclosure.

In operation S21, the processor 70 checks whether the hot water dispensing command is input through the input unit 10.

In operation S22, the processor 70 closes the first valve 60-1 when the hot water dispensing command is input through the input unit 10.

In operation S23, the processor 70 determines whether the predetermined waiting time elapses after the first valve 60-1 is closed.

In operation S24, the processor 70 closes the second valve 60-2 when the predetermined waiting time elapses after the first valve 60-1 is closed.

In operation S25, the processor 70 determines whether the predetermined waiting time elapses after the second valve 60-2 is closed.

In operation S16, the processor 70 closes the fifth valve 60-5 when the predetermined waiting time elapses after the second valve 60-2 is closed.

As described above, when the hot water is cut-off, the processor 70 may sequentially close the first valve 60-1, the second valve 60-2, and the fifth valve 60-5 with the predetermined waiting time, thereby preventing the excessive water pressure from being applied to the second valve 60-2 or the fifth valve 60-5. As a result, the second valve 60-2 and the fifth valve 60-5 may not be disturbed by the closing operation according to the water pressure.

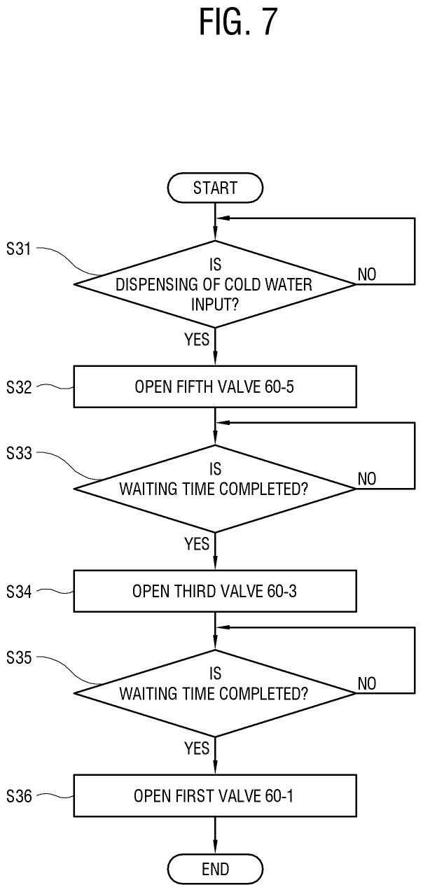

FIG. 7 is a flowchart illustrating a control method for dispensing cold water of a water purifier 1 according to an embodiment of the disclosure.

In operation S31, the processor 70 checks whether a cold water dispensing command is input through the input unit 10.

In operation S32, the processor 70 opens the fifth valve 60-5 when the cold water dispensing command is input through the input unit 10.

In operation S33, the processor 70 determines whether the predetermined waiting time elapses after the fifth valve 60-5 is opened.

In operation S34, the processor 70 opens the third valve 60-3 when the predetermined waiting time elapses after the fifth valve 60-5 is opened.

In operation S35, the processor 70 determines whether the predetermined waiting time elapses after the third valve 60-3 is opened.

In operation S36, the processor 70 opens the first valve 60-1 when the predetermined waiting time elapses after the third valve 60-3 is opened.

As described above, when the cold water is dispensed, the processor 70 may sequentially open the fifth valve 60-5, the third valve 60-3, and the first valve 60-1 with the predetermined waiting time, thereby preventing excessive water pressure from being applied to the third valve 60-3 or the fifth valve 60-5. As a result, the third valve 60-3 and the fifth valve 60-5 may not be disturbed by the opening operation according to the water pressure.

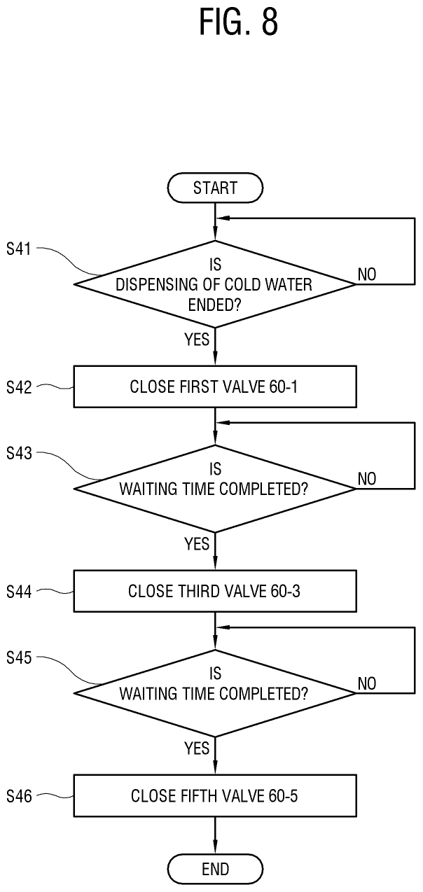

FIG. 8 is a flowchart illustrating a control method for cutting-off cold water of a water purifier 1 according to an embodiment of the disclosure.

In operation S41, the processor 70 checks whether the cold water cutting-off command is input through the input unit 10.

In operation S42, the processor 70 closes the first valve 60-1 when the cold water cutting-off command is input through the input unit 10.

In operation S43, the processor 70 determines whether the predetermined waiting time elapses after the first valve 60-1 is closed.

In operation S44, the processor 70 closes the third valve 60-3 when the predetermined waiting time elapses after the first valve 60-1 is closed.

In operation S45, the processor 70 determines whether the predetermined waiting time elapses after the third valve 60-3 is closed.

In operation S46, the processor 70 closes the fifth valve 60-5 when the predetermined waiting time elapses after the third valve 60-3 is closed.

As described above, when the cold water is cut-off, the processor 70 may sequentially close the first valve 60-1, the third valve 60-3, and the fifth valve 60-5 with the predetermined waiting time, thereby preventing the excessive water pressure from being applied to the third valve 60-3 or the first valve 60-1. As a result, the third valve 60-3 and the fifth valve 60-5 may not be disturbed by the closing operation according to the water pressure.

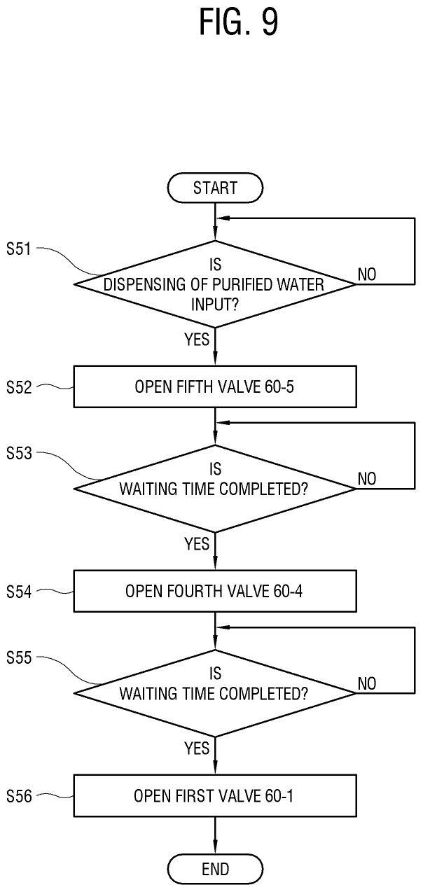

FIG. 9 is a flowchart illustrating a control method for dispensing purified water of a water purifier 1 according to an embodiment of the disclosure.

In operation S51, the processor 70 checks whether a purified water dispensing command is input through the input unit 10.

In operation S52, the processor 70 opens the fifth valve 60-5 when the purified water dispensing command is input through the input unit 10.

In operation S53, the processor 70 determines whether the predetermined waiting time elapses after the fifth valve 60-5 is opened.

In operation S54, the processor 70 opens the fourth valve 60-4 when the predetermined waiting time elapses after the fifth valve 60-5 is opened.

In operation S55, the processor 70 determines whether the predetermined waiting time elapses after the fourth valve 60-4 is opened.

In operation S56, the processor 70 opens the first valve 60-1 when the predetermined waiting time elapses after the fourth valve 60-4 is opened.

As described above, when the purified water is dispensed, the processor 70 may sequentially open the fifth valve 60-5, the fourth valve 60-4, and the first valve 60-1 with the predetermined waiting time, thereby preventing the excessive water pressure from being applied to the fourth valve 60-4 or the fifth valve 60-5. As a result, the fourth valve 60-4 and the fifth valve 60-5 may not be disturbed by the opening operation according to the water pressure.

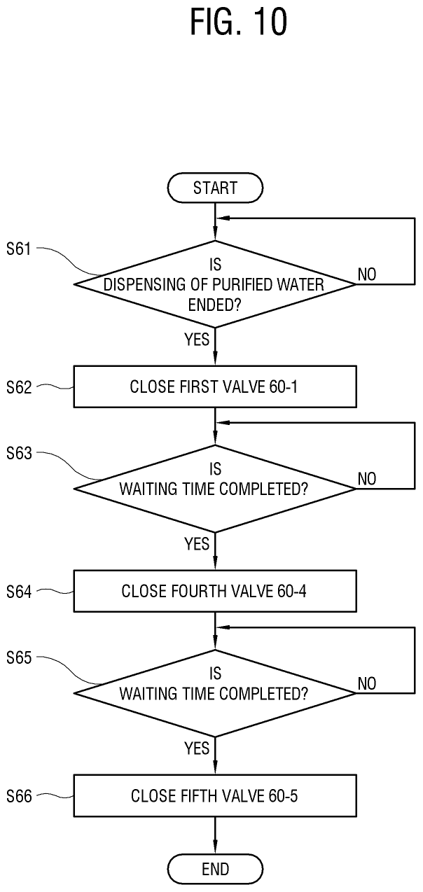

FIG. 10 is a flowchart illustrating a control method for cutting-off purified water of a water purifier 1 according to an embodiment of the disclosure.

In operation S61, the processor 70 checks whether the purified water cutting-off command is input through the input unit 10.

In operation S62, the processor 70 closes the first valve 60-1 when the purified water cutting-off command is input through the input unit 10.

In operation S63, the processor 70 determines whether the predetermined waiting time elapses after the first valve 60-1 is closed.

In operation S64, the processor 70 closes the fifth valve 60-4 when the predetermined waiting time elapses after the first valve 60-1 is closed.

In operation S65, the processor 70 determines whether the predetermined waiting time elapses after the fourth valve 60-4 is closed.

In operation S66, the processor 70 closes the fifth valve 60-5 when the predetermined waiting time elapses after the fourth valve 60-4 is closed.

As described above, when the hot water is dispensed, the processor 70 may sequentially close the first valve 60-1, the second valve 60-4, and the fifth valve 60-5 with the predetermined waiting time, thereby preventing the excessive water pressure from being applied to the fourth valve 60-4 or the first valve 60-1. As a result, the fourth valve 60-4 and the fifth valve 60-5 may not be disturbed by the closing operation according to the water pressure.

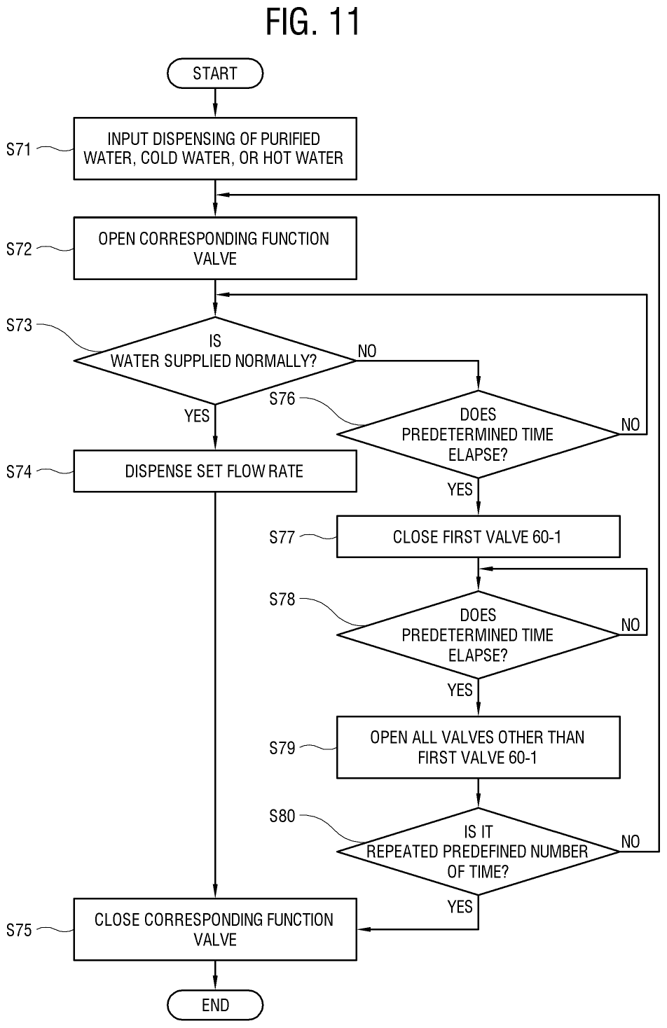

FIG. 11 is a flowchart illustrating a method for self-recovering a valve 60 of a water purifier 1 according to a first embodiment of the disclosure.

In operation S71, the processor 70 checks whether the water dispensing command or the water cutting-off command of at least one of the hot water, the cold water, or the purified water is input through the input unit 10. Hereinafter, for convenience of explanation, it is assumed that the hot water dispensing command is input through the input unit 10.

In operation S72, when the hot water dispensing command is input through the input unit 10, the processor 70 sequentially operates the fifth valve 60-5, the second valve 60-2, and the first valve 60-1, as illustrated in FIG. 5.

In operation S73, the processor 70 determines whether the hot water is normally dispensed. The determination that the hot water is normally dispensed may be determined by the flow rate of water detected by the flow rate sensor 20. When the hot water is normally being dispensed, operations S74 and S75 are performed. If the hot water is not normally dispensed, operations S76, S77, S78, S79, and S80 are performed.

In operation S74, the processor 70 dispenses water by the set flow rate.

In operation S75, the processor 70 closes the first valve 60-1, the second valve 60-2, and the fifth valve 60-5 as illustrated in FIG. 6.

In operation S76, when it is checked that the hot water is not normally dispensed, the processor 70 determines whether the predetermined waiting time elapses.

In operation S77, the processor 70 closes the first valve 60-1 when the predetermined waiting time elapses.

In operation S78, the processor 70 determines whether the predetermined waiting time elapses after the first valve 60-1 is closed.

In operation S79, if the predetermined waiting time elapses after the first valve 60-1 is closed, all the valves 60-2 to 60-6 other than the first valve 60-1 are opened.

In operation S80, the processor 70 repeats operations S72, S73, S76, S77, S78, and S79 a predefined number of times.

As described above, the method for self-recovering a valve 60 according to the embodiment of the disclosure opens the other valves 60-2 to 60-6 to recover the malfunction of at least one of the valves 60-1, 60-2, and 60-5 for dispensing the hot water due to the excessive pressure or the sandwich of foreign objects to reduce the water pressure applied to the malfunctioning valve, thereby normally opening the valves 60-1, 60-2, and 60-5 for dispensing the hot water.

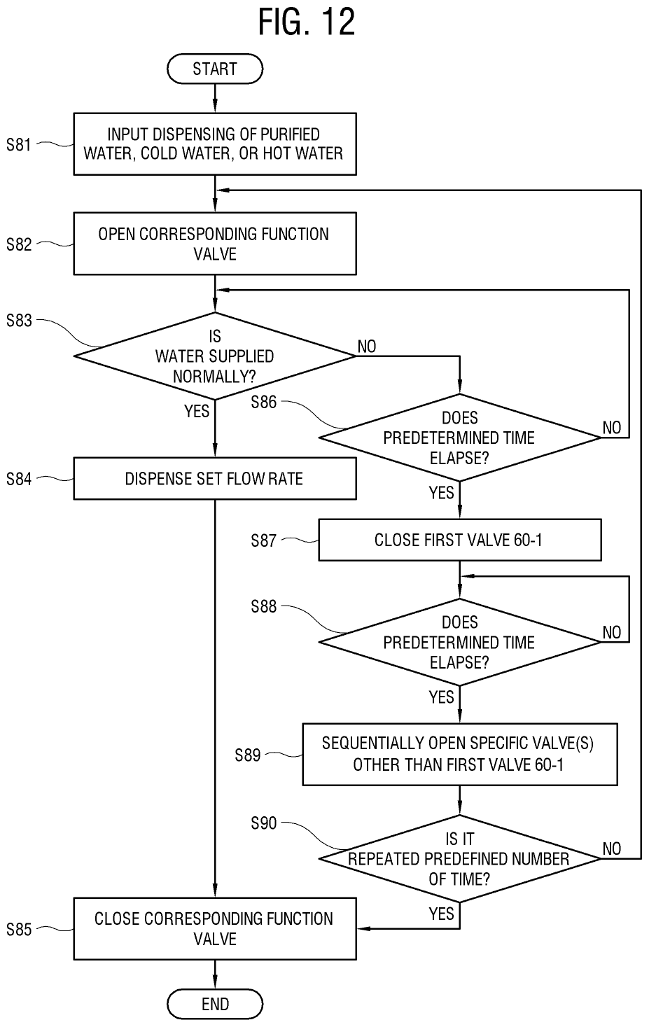

FIG. 12 is a flowchart illustrating a method for self-recovering a valve 60 of a water purifier 1 according to a second embodiment of the disclosure.

In operation S81, the processor 70 checks whether the water dispensing command or the water cutting-off command of at least one of the hot water, the cold water, or the purified water is input through the input unit 10. Hereinafter, for convenience of explanation, it is assumed that the hot water dispensing command is input through the input unit 10.

In operation S82, when the hot water dispensing command is input through the input unit 10, the processor 70 sequentially opens the fifth valve 60-5, the second valve 60-2, and the first valve 60-1, as illustrated in FIG. 5.

In operation S83, the processor 70 determines whether the hot water is normally dispensed. The determination that the hot water is normally dispensed may be determined by the flow rate of water detected by the flow rate sensor 20. When the hot water is normally being dispensed, operations S84 and S85 are performed. If the hot water is not normally dispensed, operations S86, S87, S88, S89, and S90 are performed.

In operation S84, the processor 70 dispenses water by the set flow rate.

In operation S85, the processor 70 closes the first valve 60-1, the second valve 60-2, and the fifth valve 60-5 as illustrated in FIG. 6.

In operation S86, when it is checked that the hot water is not normally dispensed, the processor 70 determines whether the predetermined waiting time elapses.

In operation S87, the processor 70 closes the first valve 60-1 when the predetermined waiting time elapses.

In operation S88, the processor 70 determines whether the predetermined waiting time elapses after the first valve 60-1 is closed.

In operation S89, when the predetermined waiting time elapses after the first valve 60-1 is closed, the processor 70 may open specific valves other than the first valve 60-1, for example, the second valve 60-2 and the sixth valve 60-6 and then sequentially or simultaneously open the third valve 60-3 and the fourth valve 60-4. Here, the specific valve to be opened and the opening order may be set in advance in the manufacturing operation of the water purifier 1.

In operation S90, the processor 70 repeats operations S82, S83, S86, S87, S88, and S89 a predefined number of times.

As another embodiment, for the self-recovery, the processor 70 may close the second valve 60-2 and open the remaining first valve 60-1 and third to sixth valves 60-3 to 60-6 when water is not normally dispensed upon the hot water dispensing command. Alternatively, when water is not normally dispensed upon the cold water dispensing command, the processor 70 may close the third valve 60-3, and open the remaining first valve 60-1, the second valve 60-2, and the fourth to sixth valves 60-4 to 60-6. Alternatively, when water is not normally dispensed upon the purified water dispensing command, the processor 70 may close the fourth valve 60-4, and open the remaining first to third valves 60-1 to 60-3, and the fifth and sixth valves 60-6 and 60-6.

As another embodiment, for the self-recovery, the processor 70 may close the first valve 60-1 and the fifth valve 60-5, and open the second to fourth valves 60-2 to 60-4, and the sixth valve 60-6. In this way, it is possible to prevent an unwanted type of water from being dispensed through the outlet 83 as other valves are opened according to the self-recovery operation in the state in which the user issues the hot water dispensing command.

As another embodiment, for the self-recovery, the processor 70 may close the fifth valve 60-5 and open the first to fourth valves 60-1 to 60-4 and the sixth valve 60-6.

As another embodiment, the water purifier 1 may include a self-recovery button so that the user may press for the self-recovery when the water dispensing or the water cutting-off is not normally made. At this time, the processor 70 repeats operations S72, S73, S76, S77, S78, and S79 or operations S82, S83, S86, S87, S88, and S89 a predefined number of times according to the input of the self-recovery button.

As another embodiment, the water purifier 1 may further include a wired or wireless communication module. The processor 70 may notify to the after-sales service server of the failure of the water purifier 1 through the wired or wireless communication module when the water dispensing or the water cutting-off is not made even by the self-recovery operation. At this time, the notified contents may include the model name, installation location, and failure details of the water purifier 1.

As described above, when some of the valves do not operate due to the excessive water pressure or the foreign objects, the water purifier according to the disclosure may control to open other valves to lower the pressure or to open and close the other valves repeatedly, thereby implementing the self-recovery of the malfunctioning valve.

Although the preferred embodiments of the disclosure have been illustrated and described above, the disclosure is not limited to the specific embodiments described above, and can be variously modified by those skilled in the art to which the disclosure pertains without departing from the gist of the disclosure claimed in the claims, and these modifications should not be understood individually from the technical ideas or prospects of the disclosure.

What is claimed is:

1. A water purifier, comprising:
a piping part configured to have a flow path between an inlet into which water is introduced and an outlet through which water is dispensed;
a plurality of valves configured to be provided along the flow path of the piping part; and
a processor configured to control to:
open at least one valve among the plurality of valves to perform a water dispensing operation of dispensing water through the outlet, and
open valves other than the at least one valve among the plurality of valves, subsequent to the at least one valve being open, to perform a recovery operation of reducing water pressure applied to the at least one valve.

2. The water purifier of claim 1, wherein the flow path comprises a first main flow path on a side of the inlet, a second main flow path on a side of the outlet, and two or more subflow paths that branch off from the first main flow path or the second main flow path.

3. The water purifier of claim 2, wherein the at least one valve is among a valve provided in the first main flow path, a valve provided in one of the two or more subflow paths, and a valve provided in the second main flow path.

4. The water purifier of claim 3, wherein the valves other than the at least one valve comprise valves provided in another of the two or more subflow paths.

5. The water purifier of claim 2, further comprising:
a filter module configured to be provided in the first main flow path and filter the introduced water;
a hot water module configured to be provided in one of the two or more subflow paths and heat water filtered by the filter module; and
a cooling module configured to be provided in another one of the two or more subflow paths and cool the water filtered by the filter module.

6. The water purifier of claim 5, wherein the plurality of valves include:
a first valve configured to be provided in the first main flow path at a rear end of the filter module;
a second valve configured to be provided at a rear end of the hot water module;
a third valve configured to be provided at a rear end of the cooling module;
a fourth valve configured to be provided in another one of the two or more subflow paths through which water from the filter module flows; and
a fifth valve configured to be provided in a second main flow path on the side of the outlet.

7. The water purifier of claim 6, wherein the two or more subflow paths are first through third subflow paths, and the flow path comprises a fourth subflow path that is branched off from a second main flow path at a front end of the fifth valve, and
the plurality of valves comprises a sixth valve provided in the fourth subflow path.

8. The water purifier of claim 6, wherein the processor is configured to control to sequentially open the fifth valve, at least one of the second valve, the third valve, or the fourth valve, and the first valve, upon a command to dispense at least one of filtered water, hot water, or cold water.

9. The water purifier of claim 6, wherein the processor is configured to control to sequentially shut-off the first valve, at least one of the second valve, the third valve, or the fourth valve, and the fifth valve, upon a command to cut off at least one of filtered water, hot water, or cold water.

10. The water purifier of claim 7, wherein the processor is configured to control to shut-off the first valve and open the second valve, the third valve, the fourth valve, the fifth valve, and the sixth valve as the water dispensing operation is not normally performed.

11. The water purifier of claim 7, wherein the processor is configured to control to shut-off the first valve and the fifth valve and open the sixth valve while opening the second valve, the third valve, the fourth valve as the water dispensing operation is not normally performed.

12. The water purifier of claim 7, wherein the processor is configured to control to shut-off the first valve and open a predefined valve among the second valve, the third valve, the fourth valve, the fifth valve, and the sixth valve as the water dispensing operation is not normally performed.

13. The water purifier of claim 1, wherein the processor is configured to control to shut-off the at least one valve among the plurality of valves and open the valves other than the at least one valve as the water dispensing operation is not normally performed.

14. The water purifier of claim 1, wherein the processor is configured to repeatedly perform a first operation of opening the at least one valve among the plurality of valves, a second operation of shutting-off the at least one valve as the water dispensing operation is not normally performed, and a third operation of opening the valves other than the at least one valve, where the third operation includes the opening of the valves other than the at least one valve a predefined number of times.

15. The water purifier of claim 1, wherein the processor is configured to control to shut-off the at least one valve among the plurality of valves and open the valves other than the at least one valve in a predefined order as the water dispensing operation is not normally performed.

16. A method for controlling a water purifier, the method comprising:
controlling to open at least one valve among a plurality of valves provided along a flow path of a piping part having a flow path between an inlet into which water is introduced and an outlet through which water is dispensed, the controlling to open the at least one valve being to perform a water dispensing operation of dispensing water through the outlet;
detecting whether the at least one valve is normally operated; and
controlling to open valves other than the at least one valve among the plurality of valves, subsequent to the at least one valve being open, to perform a recovery operation of reducing water pressure applied to the at least one valve.
